(19) United States
(12) Patent Application Publication
(10) Pub. No.: US 2008/0220746 A1
(43) Pub. Date: Sep. 11, 2008

(54) KEY ESTABLISHMENT UTILIZING LINK PRIVACY

(75) Inventor: Jan-Erik EKBERG, Vantaa (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/683,813

(22) Filed: Mar. 8, 2007

(51) Int. Cl. H04M 3/42; H04M 1/00

(52) U.S. Cl. 455/414.1; 455/550.1

(57) ABSTRACT

A system for allowing two or more wireless devices to form a secure relationship despite any other device that may be attempting to intercept information exchanged between the devices. The process may be performed automatically by the devices, yielding security information that may be used to authenticate information believed to have been sent from a known device. The security information may include at least an encryption key utilized to identify previously encountered known devices and for securing communication with these devices. The security key may be computed by analyzing the transmission and receipt of advertising messages, or by analyzing the contents of pseudorandom information contained in advertising message payloads.

### BACKGROUND OF THE INVENTION

1. Field of Invention

The present invention relates to a system for enhancing security in a device communicating via a wireless communication medium, and more specifically to a system for automatically pairing wireless communication devices through the formation of a secure key.

2. Description of Prior Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate WCD communication over large geographic areas. These network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced data rate (EDR) technology also available may enable maximum asymmetric data rates of 1448 Kbps for a 2 Mbps connection and 2178 Kbps for a 3 Mbps connection. A user is not required to actively instigate a Bluetooth™ network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

More recently, manufacturers have also begun to incorporate various resources for providing enhanced functionality in WCDs (e.g., components and software for performing close-proximity wireless information exchanges). Sensors and/or readers may be used to read visual or electronic information into a device. A transaction may involve a user holding their WCD in proximity to a target, aiming their WCD at an object (e.g., to take a picture) or sweeping the device over a printed tag or document. Machine-readable technologies such as radio frequency identification (RFID), Infra-red (IR) communication, optical character recognition (OCR) and various other types of visual, electronic and magnetic scanning are used to quickly input desired information into the WCD without the need for manual entry by a user.

Device manufacturers are continuing to incorporate as many of the previously indicated exemplary communication features as possible into wireless communication devices in an attempt to bring powerful, “do-all” devices to market. Devices incorporating long-range, short-range and machine readable communication resources also often include multiple wireless mediums or radio protocols for each category. A multitude of wireless media options may assist a WCD in quickly adjusting to its environment, for example, communicating both with a WLAN access point and a Bluetooth™ peripheral device, possibly (and probably) at the same time.

Given the large array communication features that may be compiled into a single device, it is foreseeable that a user will need to employ a WCD to its full potential when replacing other productivity related devices. For example, a user may use a multifunction WCD to replace traditional tools such as individual phones, facsimile machines, computers, storage media, etc. which tend to be more cumbersome to both integrate and transport. In at least one use scenario, a WCD may be communicating simultaneously over numerous different wireless mediums. A user may utilize multiple peripheral Bluetooth™ devices (e.g., a headset and a keyboard) while having a voice conversation over GSM and interacting with a WLAN access point in order to access the Internet.

While a WCD may engage in wireless communication with a multitude of other devices concurrently, in some instances a resource constraint may arise where two or more of the peripheral devices are communicating using radio protocols that are implemented into a single radio modem in the WCD. Such a scenario may occur, for example, when both a Bluetooth™ device and a Wibree™ device are being used concurrently. Wibree™ is an open standard industry initiative extending local connectivity to small devices with technology that increases the growth potential in these market segments. Wibree™ technology may complement close range communication with Bluetooth™-like performance in the 0-10 m range with a data rate of 1 Mbps. Wibree™ is optimized for applications requiring extremely low power consumption, small size and low cost. Wibree™ may be implemented either as stand-alone chip or as Bluetooth™-Wibree™ dual-mode chip. More information can be found on the Wibree™ website: www.wibree.com.

A problem that may be encountered in low power devices is the implementation of adequate security measures. Low power and/or low complexity devices often are limited with regard to space, power, flexibility, communication ability (e.g., connection protocols supported), etc. As a result, there may not be adequate resources to support a user interface or other similar control aspects commonly used in initiating and maintaining security information. This limitation may especially affect ultra-low power devices such as sensors. These wireless devices may be placed in locations not conducive to manual control, or may be designed for environments that require special hardening again harsh conditions that would make it impossible to include control features. These characteristics may create difficulty when establishing security measures, and therefore, leave these devices open to malicious attacks.

In view of this problematic situation, what is therefore needed is security strategy that will allow wireless devices to maintain strong encryption regardless of the complexity of the device. The security system should facilitate the devices in automatically negotiating a strong encryption key, which would allow the devices to form a “paired” relationship without yielding this information to other devices which might be eavesdropping on inter-device communication.

### SUMMARY OF INVENTION

The present invention includes at least a method, device, computer program and system for allowing two or more wireless devices to form a secure relationship despite any other device that may be attempting to intercept information exchanged between the devices. The process may be performed automatically by the devices, yielding security information that may be used to authenticate information believed to have been sent from a known device. For example, this the security information may include at least an encryption key utilized to identify previously encountered known devices and for securing communication with these devices. Further, any information obtained by an eavesdropping third-party device may be rendered useless, for example, because the information may appear to be coming from only one device, and further, payload content within the intercepted information may be deemed to be random.

In at least one embodiment of the present invention, one or more WCDs may utilize the same public address when transmitting messages advertising their presence and possible desire to communicate. These messages may be differentiated between known devices, but may appear as to be coming from only one device to attackers since the same public address is used by all WCDs. In at least one scenario, these advertising messages do not include any useful information that could be intercepted by a third party. Instead, the actual pattern formed by the transmission and receipt of the messages over a predetermined period of time may be utilized to compute an encryption key. In this process, a certain pattern of advertising message transmission and receipt may meet a predetermined condition that indicates a particular bit (e.g., a “0” or “1”) that may be added to an encryption key. This information may be interpreted similarly by known devices, allowing an identical security key to be formed in each WCD. The security information may be later used to identify a known device and for secure communication.

In another example of the present invention, the advertising messages may further contain payload information in addition to address information. The payload information may be formulated to appear random to an observer, but may instead be based on a pseudorandom algorithm utilized by known devices in formulating an encryption key. The pseudorandom payload may be used to identify messages that were sent vs. messages that were received from another device. This determination may be made, for example, through the use of checksums. Conditions then associated with this determination may be used to indicate whether a bit (e.g., a “0” or “1”) may be added to a security key. The security key may then be used, for example, to identify a previously encountered device and to secure communication between known devices.

### DESCRIPTION OF DRAWINGS

The invention will be further understood from the following detailed description of a preferred embodiment, taken in conjunction with appended drawings, in which:

FIG. 1 discloses an exemplary wireless operational environment, including wireless communication mediums of different effective range.

FIG. 2 discloses a modular description of an exemplary wireless communication device usable with at least one embodiment of the present invention.

FIG. 3 discloses an exemplary structural description of the wireless communication device previously described in FIG. 2.

FIG. 4 discloses an exemplary communication between two wireless communication devices in accordance with at least one embodiment of the present invention.

FIG. 5A discloses an example of an active accumulation of device information by an attacking wireless communication device against other wireless communication devices which is a motivation for at least one embodiment of the present invention.

FIG. 5B discloses an example of a passive accumulation of device information by an attacking wireless communication device against other wireless communication devices which is a further motivation for at least one embodiment of the present invention.

FIG. 5C discloses an example of an active location determination of a wireless communication device by an attacking wireless communication device which is a further motivation for at least one embodiment of the present invention.

FIG. 6A discloses at least one embodiment of the present invention as it pertains to at least one condition that may be utilized in the formation of a encryption key.

FIG. 6B discloses at least one embodiment of the present invention as it pertains to at least one condition that may be utilized in the formation of a encryption key.

FIG. 6C discloses at least one embodiment of the present invention as it pertains to at least one condition that may be utilized in the formation of a encryption key.

FIG. 6D discloses at least one embodiment of the present invention as it pertains to at least one condition that may be utilized in the formation of a encryption key.

FIG. 7 discloses an example of the formation of an encryption key in accordance with at least one embodiment of the present invention.

FIG. 8 discloses a flow chart describing an encryption key formation process in accordance with at least one embodiment of the present invention.

FIG. 9 discloses an alternative key formation process in accordance with at least one embodiment of the present invention.

FIG. 10 discloses a flow chart describing an encryption key formation process in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Over Different Communication Networks

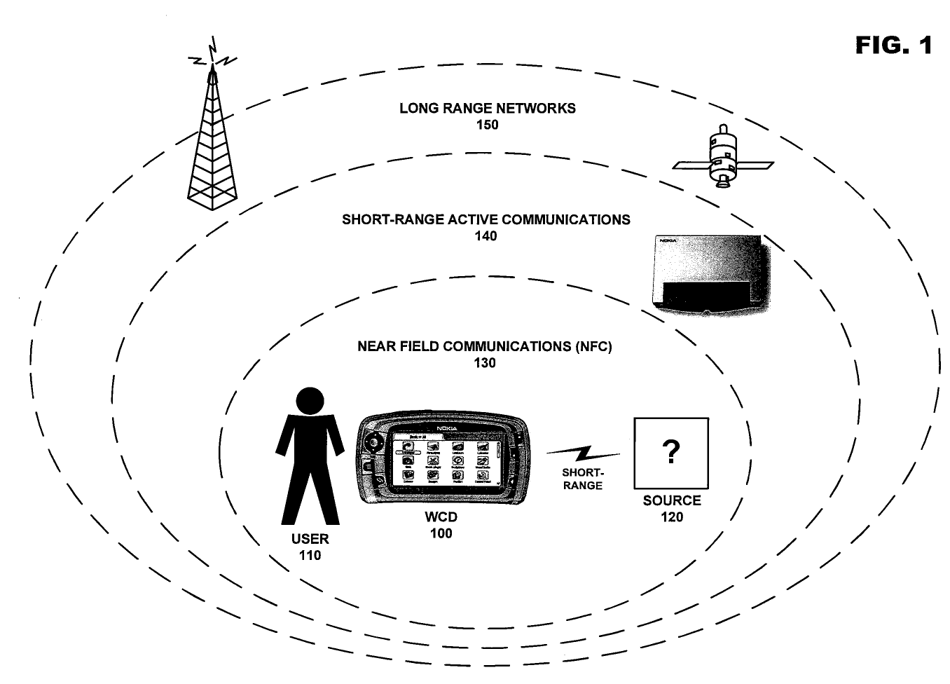

A WCD may both transmit and receive information over a wide array of wireless communication networks, each with different advantages regarding speed, range, quality (error correction), security (encoding), etc. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from one or more simple embedded devices/sensors to a more complex cellular handset or a wirelessly enabled palmtop or laptop computer. Near Field Communication (NFC) 130 includes various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range on the order of ten feet, and may be able to deliver stored data in amounts from 96 bits to over a megabit (or 125 Kbytes) relatively quickly. These features make such technologies well suited for identification purposes, such as to receive an account number for a public transportation provider, a key code for an automatic electronic door lock, an account number for a credit or debit transaction, etc.

The transmission range between two devices may be extended if both devices are capable of performing powered communication. Short-range active communication 140 includes applications wherein the sending and receiving devices are both active. An exemplary situation would include user 110 coming within effective transmission range of a Bluetooth™, WLAN, UWB, WUSB, etc. access point. In the case of Wibree™, a network may be established to transmit information to WCD 100 possessed by user 110. Wibree™ may be used for battery-powered devices, such as wireless sensors, since its power consumption is low. A Wibree™ slave device may use an advertisement mode (or a scan mode in a master device) to more rapidly establish the initial connection to WCD 100. The amount of information that may be conveyed is unlimited, except that it must all be transferred in the time when user 110 is within effective transmission range of the access point. This duration may be extremely limited if the user is, for example, strolling through a shopping mall or walking down a street. Due to the higher complexity of these wireless networks, additional time is also required to establish the initial connection to WCD 100, which may be increased if many devices are queued for service in the area proximate to the access point. The effective transmission range of these networks depends on the technology, and may be from some 30 ft. to over 300 ft. with additional power boosting.

Long-range networks 150 are used to provide virtually uninterrupted communication coverage for WCD 100. Land-based radio stations or satellites are used to relay various communication transactions worldwide. While these systems are extremely functional, the use of these systems is often charged on a per-minute basis to user 110, not including additional charges for data transfer (e.g., wireless Internet access). Further, the regulations covering these systems may cause additional overhead for both the users and providers, making the use of these systems more cumbersome.

### II. Wireless Communication Device

As previously described, the present invention may be implemented using a variety of wireless communication equipment. Therefore, it is important to understand the communication tools available to user 110 before exploring the present invention. For example, in the case of a cellular telephone or other handheld wireless devices, the integrated data handling capabilities of the device play an important role in facilitating transactions between the transmitting and receiving devices.

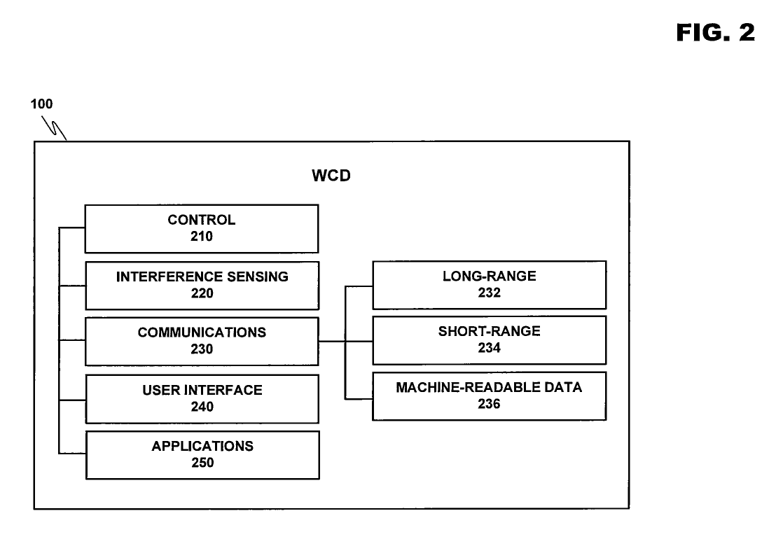

FIG. 2 discloses an exemplary modular layout for a wireless communication device usable with the present invention. WCD 100 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs, and in response, may issue control commands to the other modules in WCD 100.

Communications module 230 incorporates all of the communication aspects of WCD 100. As shown in FIG. 2, communications module 230 may include, for example, long-range communications module 232, short-range communications module 234 and machine-readable data module 236 (e.g., for NFC). Communications module 230 utilizes at least these sub-modules to receive a multitude of different types of communication from both local and long distance sources, and to transmit data to recipient devices within the transmission range of WCD 100. Communications module 230 may be triggered by control module 210, or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

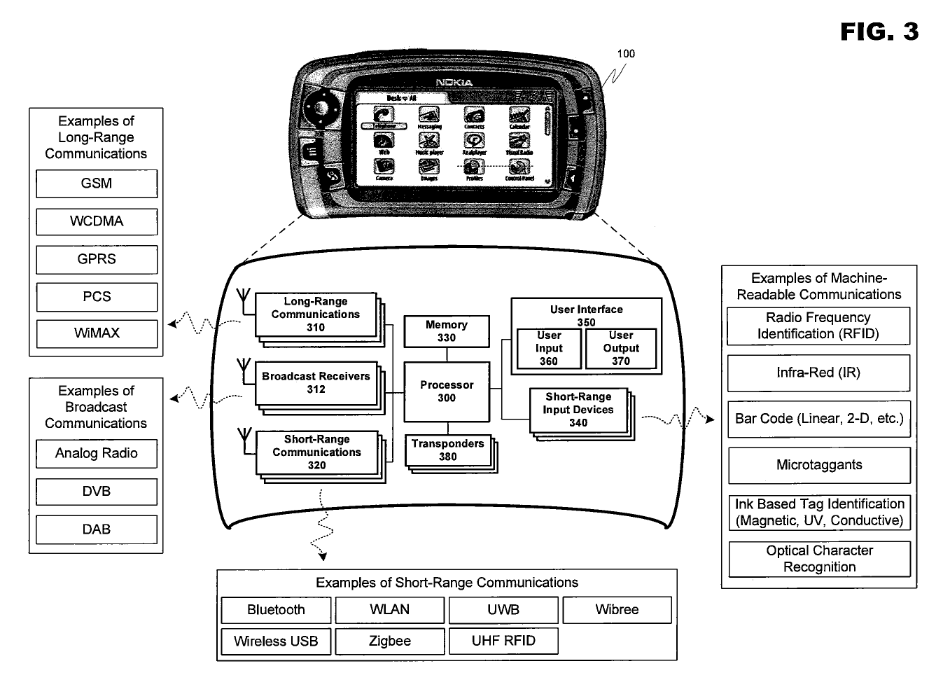

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to at least communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communication utilities modules required to support WCD 100.

Long-range communications 310 performs functions related to the exchange of information over large geographic areas (such as cellular networks) via an antenna. These communication methods include technologies from the previously described 1G to 3G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300, transmission receiver 312 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 320 is responsible for functions involving the exchange of information across short-range wireless networks. As described above and depicted in FIG. 3, examples of such short-range communications 320 are not limited to Bluetooth™, Wibree™, WLAN, UWB and Wireless USB connections. Accordingly, short-range communications 320 performs functions related to the establishment of short-range connections, as well as processing related to the transmission and reception of information via such connections.

Short-range input device 340, also depicted in FIG. 3, may provide functionality related to the short-range scanning of machine-readable data (e.g., for NFC). For example, processor 300 may control short-range input device 340 to generate RF signals for activating an RFID transponder, and may in turn control the reception of signals from an RFID transponder. Other short-range scanning methods for reading machine-readable data that may be supported by short-range input device 340 are not limited to IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for short-range input device 340 to scan the aforementioned types of machine-readable data, the input device may include optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID reader mounted in an entryway may continuously emit radio frequency waves. When a person with a device containing transponder 380 walks through the door, the transponder is energized and may respond with information identifying the device, the person, etc. In addition, a reader may be mounted (e.g., as discussed above with regard to examples of short-range input device 340) in WCD 100 so that it can read information from other transponders in the vicinity.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communication components stored in memory 330.

The elements shown in FIG. 3 may be constituted and coupled according to various techniques in order to produce the functionality described in FIG. 2. One such technique involves coupling separate hardware components corresponding to processor 300, communications sections 310, 312 and 320, memory 330, short-range input device 340, user interface 350, transponder 380, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communication utilities software component, also contained in memory 330, which provides for the establishment of service sessions using long-range communications 310 and/or short-range communications 320. The communication utilities component may include various routines that allow the reception of services from remote devices according to mediums such as the Wireless Application Medium (WAP), Hypertext Markup Language (HTML) variants like Compact HTML (CHTML), etc.

### III. Communication Between Wireless Communication Devices and the Vulnerabilities Therein

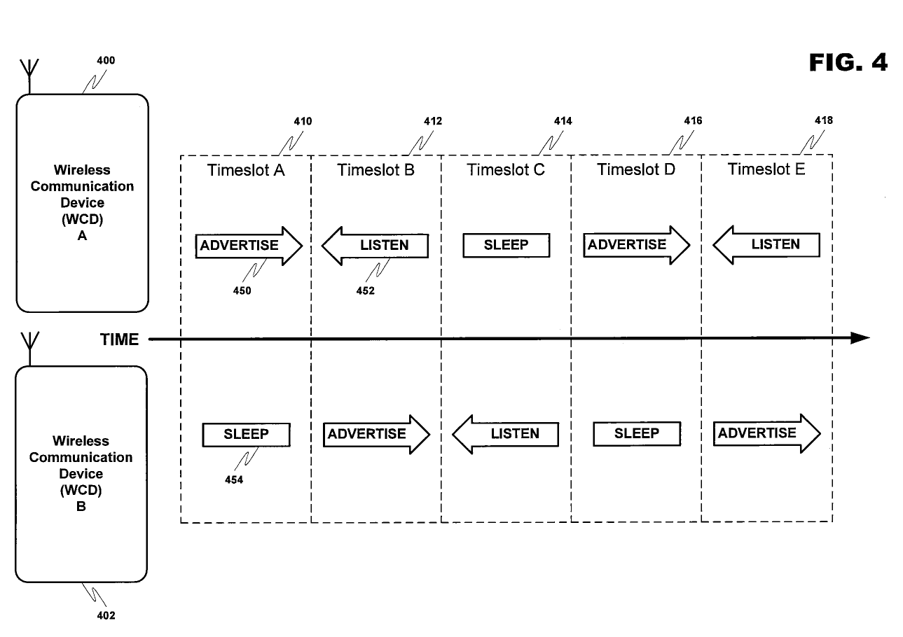

Referring now to FIG. 4, exemplary communication between two wireless communication devices in accordance with at least one embodiment of the present invention is disclosed. In this specification, Wibree™ communication is often used for the sake of example, however, the present invention is applicable to any type of short-range wireless communication wherein pairing may occur. Common examples of applicable communication mediums may include Bluetooth™, WLAN, Wireless USB, etc.

WCD A 400 and WCD B 402 are establishing an exemplary communication link in FIG. 4. These devices may periodically send messages in a given time slot 410-418. For example, WCD A 400 may transmit an advertising message 450 in timeslot A 410 while WCD B 402 is in a power conservation or sleep mode 454. The advertising message may include information such as address information and payload information for other devices to use, for example, in forming a wireless connection to WCD A 400. The sleep mode may be used by a low power device in order to conserve battery resources. In the next time slot, timeslot B 412, WCD A 400 may enter a listening mode 452 in order to scan for a reply to the advertising message 450. A replying device may indicate the desire to form a wireless network connection with WCD A 400 in order to exchange information. The progression of different modes may proceed as shown in timeslots C-E (414-418). It is important to note that a WCD 100 cannot send and receive information concurrently over the same wireless communication medium in the same timeslot. Therefore, only one communication action is shown per device in each time slot.

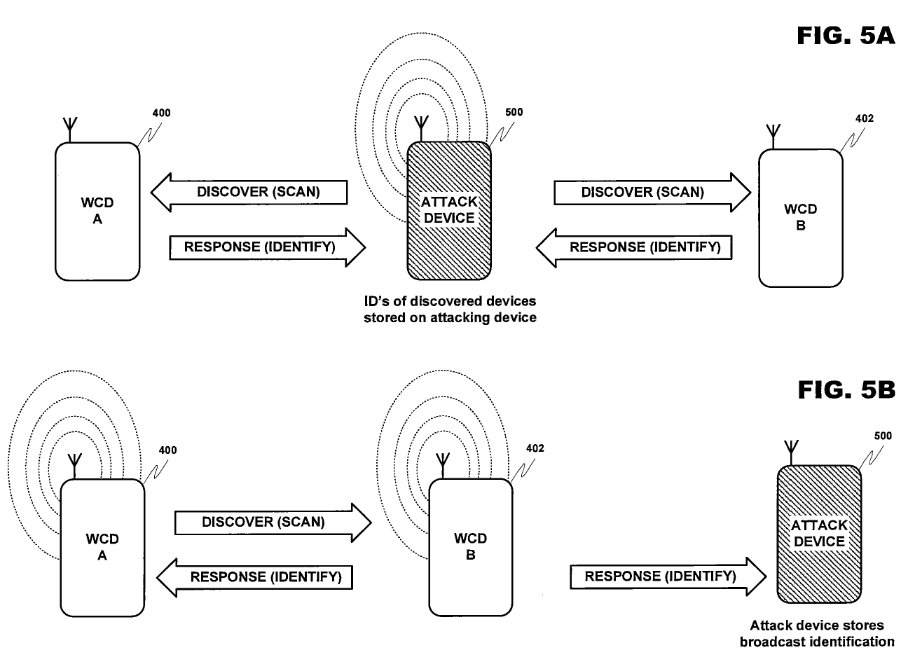

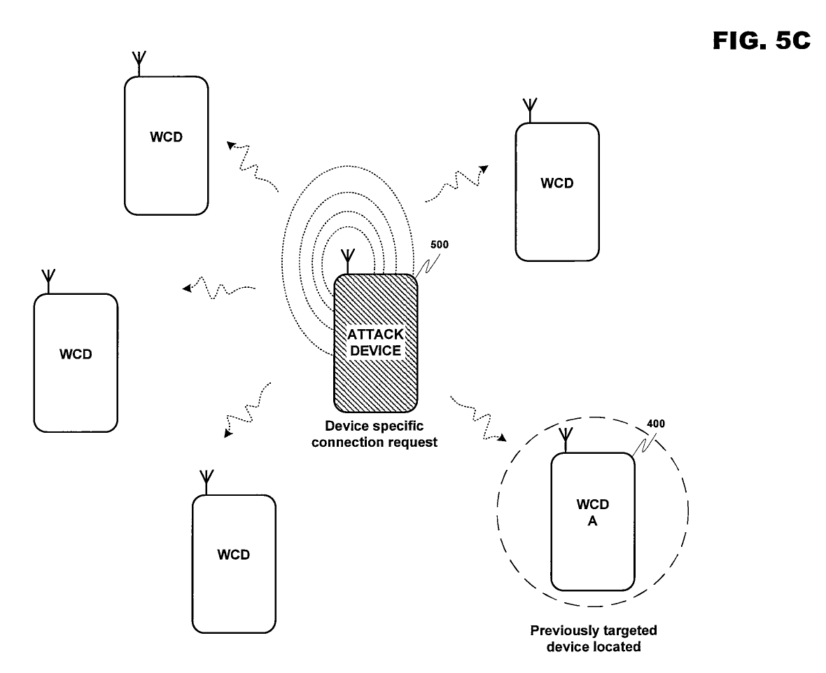

FIG. 5A gives an example scenario of an “attack” device 500 obtaining information from one or more devices present within effective transmission range. Attack device 500 may actively poll for connection with other devices in the immediate area. This polling may occur over a short-range wireless medium 140 such as Bluetooth™, or other similar medium as previously described. If WCD A 400 and WCD B 402 are left in a receptive or discoverable mode, these devices may automatically respond and identify themselves to attack device 500. As a result, attack device 500 may store the received identification information for use in tracking these devices and/or possibly accessing the contents of these devices at a later time. Therefore, attack device 500 in this example actively seeks out devices in a permissive mode on which to prey, and may be positioned near an Internet access point (AP) or other highly-trafficked communication area where users would be more likely to have the communication features enabled in their WCD 100.

As is further disclosed in FIG. 5B, attack device 500 does not have to actively send polling or inquiry messages in order to obtain identification information from another device. In this scenario, WCD A 400 and WCD B 402 are actively engaged in a wireless transaction. As previously described, the address of the devices, or identifiable parts of this address in the form of access codes, will be exchanged between the two devices. However, it is important to keep in mind that this is wireless, not wired communication. Information does not travel exclusively from WCD A 400 to WCD B 402 and vice versa. The identification information is broadcast, and may be picked up by any device within effective transmission range of the particular wireless medium. Normally, this information is ignored by another WCD 100 if it is not addressed to it. However, attack device 500 may lurk in the background and accumulate this information without having to actively connect to another communication device. As a result, attack device 500 may be able to secretly obtain identification information that may be in turn be used in a malicious manner to track the whereabouts of a particular device, or alternatively, to gain access to private information.

An example of attack device 500 employing identification information to track the whereabouts of a WCD A 400 is disclosed in FIG. 5C. In this example, attack device 500 is polling all of the devices within effective transmission range (wherein, the actual distance wireless medium dependant) in order to determine if WCD A is in the area. In the case of Bluetooth™ communication, the range could include over a 300 ft. radius with proper power boosting. If WCD A 400 responds to the poll, attack device 500 may identify WCD A 400 as the desired target device, and notify the user of attack device 500 that a particular target person is within effective transmission range. This information may then be used to commit malicious or hostile acts against the user of WCD A 400.

### IV. General Pairing Process in a Wibree™ Environment.

In order to better understand the present invention, a discussion of general pairing strategies in Wibree™ communication is now disclosed. The pairing algorithms supported by the Wibree™ host specification are geared towards sensors and the fact that limitations may be present in the availability of user interfaces, processing power, available memory and algorithmic support. The supported pairing procedures consists of: (1) The advertiser sending the keys in plaintext to the initiator. This procedure may include two augmented modes—one where the key is changed the first n connections (e.g., if an attacker misses one of the updates, security is increased). The first augmentation mode may be especially suited for pairs of mobile devices. The second augmented mode improves key security on the assumption that two devices advertising with the same address are indistinguishable to the attack hardware, and can be considered suitable in a home/fixed environment. (2) A pre-existing key is used to bootstrap security. This mode may be used for key-entry solutions, where one or both devices has manufacturer-installed fixed keys, or e.g. when an application-level pairing mechanism (e.g., in an earlier connection) is used to construct a key which is later used to exchange keys. (3) Bluetooth Simple Pairing is optionally supported for profiles requiring this functionality. The host specification may specify the communication channel for the Wibree™ adaptation, but it is assumed that profiles requiring the functionality define the context and scale of the adaptation.

The pairing is carried out in two phases, preceded by a pairing feature exchange using Start Pairing Request & Start Pairing Response. These messages are always exchanged in the beginning of an open connection, constituting phase 0 of the pairing operation. The logic by which pairing is requested may not be explicitly specified, for example, a sensor (advertiser) always initiates pairing on an open connection connect, a sensor (advertiser) always initiates pairing on an open connection connect until the first pairing has been successfully concluded, then may reject future open connections, and an initiator may initiate pairing with an advertiser based on user input. The first phase of the pairing follows a successful pairing feature exchange. The first stage is not protected by encryption. For augmentation the first stage of the pairing can be entered directly at connection ((e.g., with a specific bit (PI) set in the connection request, and the security bit turned off). For the plaintext key transfer and pre-existing key transfer options patterns are given in the following subsections. The second phase of the pairing may be carried out in an encrypted channel, protected with a temporary key either being the result of stage 1 or an earlier phase of augmentation. The second stage of the pairing can be entered directly (with the PI bit set in the connection request). In this protected channel either: (1) Long-term keys and identities are delivered (from future advertisers to future initiators) (2) Augmented (temporary) keys and identities are delivered (from future advertisers to future initiators). For indistinguishability augmentation, a limited key exchange takes place.

The third stage is not directly related to pairing. Instead, it is a normal session that may continue with the same key protection that was used during the second stage of the pairing. Note that extensive communication with this keying may cause (depending on the pairing mechanism) increased attack possibilities against the communicated long term keys AND that the bit range of the key deployed during an extension to the second stage may be less that the full 128-bits provided by the long-term keys. The third stage provides convenience and usability for augmented modes, and possible also for simple devices. In the first phase of the pairing, a shared common key is established. The subsections define the individual processes during stage

The first stage of the pairing produces a shared key “SK.” It is possible to enter phase 1 of the pairing by a connect request with the PI bit set (and the SEC bit unset). Plaintext key pairing is the simplest pairing algorithm provides no protection against an attacker in the time and place when the pairing is carried out. It consists of two messages, a 16-bit random vector RAND sent in the Key transform PDU from the initiator and a key check PDU as a response from the advertiser. Both devices calculate the shared key as

TK={0x00,0x00,0x00,0x00,0x00,0x00,0x00,0x00,0x00,0x00,0x00,0x00,0x00,0x00,0x00,0x00}

SK=E_{TK}(RAND)

This exemplary pairing mode can be augmented in two ways, either achieving “full” security at the third connection or after n connections. If the devices, due to some other connection medium, key input possibility or other reason have a shared secret that can be used as a seed for pairing, the pre-shared key pairing can be used. The signaling is equivalent to plaintext key pairing. The temporary key TK may be calculated as the O-padded hash (divisible by 16 bytes) using the AES encryption block in a Davies-Meyer construct (Hᵢ=Eₘ_{ᵢ}(Hᵢ₋₁)⊕Hᵢ₋₁), where mₓ is the 16-byte message block, the final Hₓ the resulting key TK. The initial H₀ is defined by

H₀={0x00,0x00,0x00,0x00,0x00,0x00,0x00,0x00,0x00,0x00,0x00,0x00,0x00,0x00,0x00,0x00}

The signaling and RAND handling is done as in plaintext key pairing, and

SK=E_{TK}(RAND).

The BT simple pairing may be supported by the host in the form of signaling parameters. Stage 1 of the pairing mechanism as well as the algorithmic placement of functionalities it out of scope for this document. Instead, after the Start-Pairing negotiation, a connection-oriented PAL channel shall be set up by the relevant profile, the channel number for the external pairing is a defined PSM value. After the pairing has resulted in a shared key SK the channel shall be terminated. The pairing must end in a Key check message originating from the advertiser, whereby Stage 2 of the pairing is initiated.

For the second phase of the pairing, the shared key SK generated in phase 1 (and IV as described in the “encrypted session setup-section”) are used to initiate an encrypted session. It is possible to enter phase 2 of the pairing by a connect request with the PI and SEC bits set. See the chapter on augmentation for details. In stage 2 of the pairing, the initiator (if it has indicated key transfer to the client) first sends its key material to the advertiser. When the advertiser has received both the LTK and the IR (during augmentation, temporary identities (PIRs) shall be transmitted instead of the base identity IR), it sends the respective parameters to the initiator. The messages shall be sent in the order (1) Long-term-key, and (2) Identity-key. Thus, either on the advertiser receiving the initiator's identity (if the advertiser indicated not to reveal its keys) or on the initator receiving the advertiser's identity phase 2 is considered done. The devices may optionally continue communicating (phase 3).

Augmentations for plaintext pairing include augmentation modes for that may improve pairing security where one party is a sensor or some other simple device where security is needed but the overhead of more complex algorithms is deemed to be not cost-effective. Neither mode requires user interaction and the interference to connections are kept to a minimum. Timing values for advertisement augmentation may be adjusted so that if a dual-mode chip can support a mouse, it should be able to perform augmentation without penalty on the BT side.

The augmentation modes may chain two or more connections using the PI bit in the connect request PDU. A connect with SEC=0, PI=1 invokes pairing in stagel, more specifically, the advertisement augmentation. A connect with SEC=1, PI=1 sets a connection in encrypted mode with an immediate pairing stage 2 invocation, this is used for follow-up connections in the re-connect augmentation. An advertiser that is not involved in augmented pairing at the time of such a connect should reject the connection. Augmentation is mainly attractive for use cases where the advertiser is a simple device with no host capability and sometimes no persistent storage. The algorithms reflect this, and the key exchange (stage 2) is one-directional only (e.g., advertiser to initiator). In case mutual key exchange is wanted with augmentation, the other direction is easily achieved with pre-existing key pairing or a new augmented plaintext pairing.

Reconnect augmentation makes sense for (asymmetric) pairs of mobile devices where the continuous monitoring of the devices is difficult for the attacker. Reconnect augmentation makes only limited sense in fixed installations. A reconnect augmentation is a repetitive invocation of the second phase of the pairing with some extra logic in the advertiser. The main flow of the communication is shown in the subsequent figure. The advertiser may, during the augmentation phase, distribute the PIR rather than the IR as identity. It will also construct its private address (if used) so that a matching based on PIR can be done. It is assumed that the PIR will not change during augmentation or even otherwise. The long-term key during pairing is proposed to come from the same diversification space as the final long term-keys. The advertiser is, however, free to use any key set during augmentation—this is not visible to the initiator. The proposed algorithm for an advertiser supporting augmented pairing is: (1) reserve a set of diversifiers for augmentation only, say diversifiers 0xB000 forward, and never use these as final diversifications, (2) On the first (pairing) connect, (3) diversify the PIR as instructed in the privacy chapter, (4) on plaintext pairing, indicate retransmission augmentation, (5) Give a (temporary) long-term key with and initial diversifier i=k and the PIR to the peer, (6) On subsequent connects, if PIR=1 and SEC=1, (7) Decrypt the diversifier based on PDHK, (8) Check that the diversifier is either k or k−1, if not, then abort, (9) Set up the encrypted connection as a normal encrypted connection with the (temporary) LTK (here the initial communication should be the phase 2 of the pairing). (9) Give a (temporary) LTK with diversifier k+1 and the PIR (same as earlier) to the peer. However, if k−i>X, then give a LTK from the actual diversification space and the IR. X is the amount of iterations to be done, X must be >1.

The proposed algorithm for an initiator supporting augmented pairing is: (1) Connect in open mode (plaintext pairing with re-connect augmentation is initiated), (2) Receive an LTK and a PIR, (3) Keep state that this device is in augmentation, (4) When scanning for the device, scan with the understanding that PIR is used. On subsequent connections, (5) Connect in encrypted mode (PI-bit set), (6) Receive an LTK and a (P)IR, (7) If the received IR !=the earlier received PIR conclude that now the final keying (LTK/IR) was received. Thereafter, scan with the understanding that IR is used.

### V. Key Establishment Through Timed Reception of Advertisement Messages.

In accordance with at least one embodiment of the present invention, the establishment of a key between devices that do not share a common secret is a process often called pairing. This process, in many cases, requires user involvement to ascertain some proof against man-in-the middle attacks. A good example is the Bluetooth™ simple pairing specification. On the other hand, many devices that need pairing support may not include a user interface. Generally the whole class of embedded computing devices are typically in this category. In addition, many of the currently proposed pairing algorithms are algorithmically complex, a fact that is a definite cost issue for the aforementioned class of devices. Using an out-of-band channel is for the same class of devices often too expensive.

With introduction of the Wibree™ radio specification, the issue of address privacy is for the first time addressed in a larger sense. This has the side-effect that the address used by the terminal is to a large degree controllable by terminal software. A pairing mechanism can be devised to make use of this fact.

The main features of a pairing algorithm, is that an end result of the algorithm should be such that a generated key (1) Is secure in relation to an eavesdropper (e.g., on the communication channel), (2) Is secure against a man-in-the middle on the communication channel. With simple user precaution (like keeping the devices close to each other when pairing) the algorithm described below is secure against both attacks, at least to attack devices less capable than highly sensitive, professional spectrum analyzers with antenna triangulation. The security of the mechanism relies solely on the fact that two devices, when broadcasting the same address, may be indistinguishable when located in close proximity to each other. It would require advanced electronic equipment to deduce a consistent difference in power levels (or some other transmission pattern) between the two devices for the purpose of breaching security.

The benefit of the proposed algorithm is that no user intervention is needed. Additionally, the incremental structure of the algorithm makes it easy to (1) display the strength of the currently generated key and (2) to weight the time used for pairing against the resulting key strength. The algorithm may be deemed trivial and its implementation compact. It requires a notion of time (some form of clock) to work. It is most probably not very fast (at least for Wibree™), but this is compensated by the lack of needed user invention, and the fact that pairing is a rarely needed function.

The algorithm uses device advertisements as the source of key data. The Wibree™ privacy mechanism defines a way to identify the identity source of a given address, and this mechanism is used to bring variation and thus some difficulty in spectrum and power analysis. However, the same mechanism is completely usable with static addresses as well. A basic premise for the algorithm, and how it is laid out here, is that a device cannot listen (=scan) and advertise at the same time. The algorithm can be somewhat simplified if this feature can be assumed. During one round of the pairing, one of the pairing devices will start out as the token holder. Initially this may be either of the devices (e.g., the device whose initial address was “bigger” according to an integer ordering). During the pairing the devices will present themselves with the same address. As both devices may either scan or advertise, at the beginning of the first timeslot the device (according to its role) will randomly decide whether (1) It will advertise or not in order to try to take the token from the other device (e.g., this may be the listener device), or (2) It will advertise or not during timeslot A (e.g., this may be the token holder device).

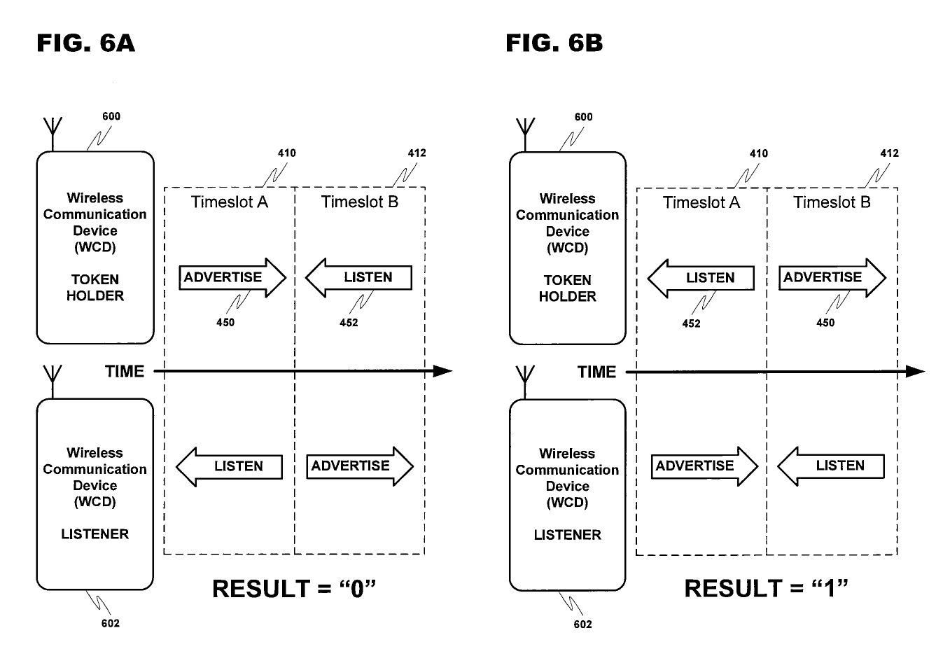

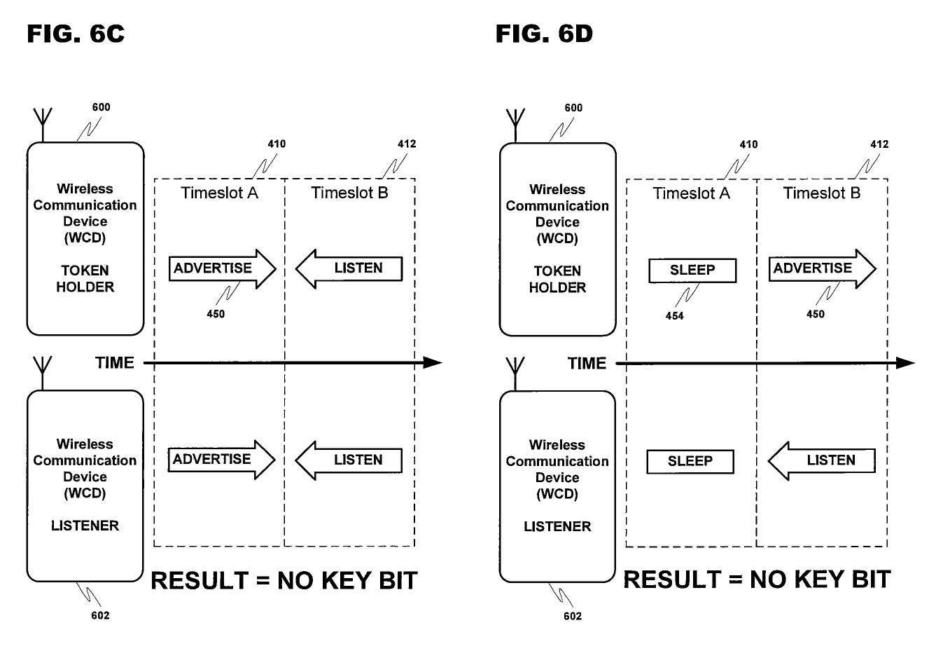

Having decided its policy, the device will carry it out. Both (1) and (2) decisions may be done with a 50% distribution between options. Possible options for such a scheme, including exemplary predetermined conditions that may be utilized with at least one embodiment of the present invention to compute security information, are disclosed in FIG. 6A-6D. However, it should be noted that probability of the decisions may vary depending on the current implementation, and the present invention is not intended to be limited to any specific probability. In the first example case disclosed in FIG. 6A, the token holder 600 may decide to advertise in the first timeslot 410 (50% probability), and the listener 602 does not try to take the token (50% probability). In this case, the probability of which is 25% of the time may not result in a token move, but represents e.g. a “0”-bit in the generated key (the attacker cannot deduce which device sent the advertisement). Both parties agree on the outcome, and the roles remain.

The second exemplary scenario utilized for conditional determination as depicted in FIG. 6B may be considered equivalent to the first, with the exception that the roles (listener 600, token holder 602) may be exchanged as a result of the transaction. The transaction is considered to be a “1”-bit in the resulting key. However, it should also be noted that, in accordance with at least one alternative embodiment of the present invention, the decisions for “0” and “1”-bits may also be defined the other way around, so that the generation of, for example, the “1”-bit may be done according to the scheme illustrated in FIG. 6A.

Now referring to FIG. 6C, in the third exemplary predetermined condition, both devices independently decide to transmit during the first timeslot. Thus, although obvious to an eavesdropper, neither device noticed the advertisement of the counterpart. Now the listener 602 assumes it “took the token”, and is waiting for an advertisement from the old token holder 600. However it is under the impression that it still is the token holder, and thus no synchronization advertisement is transmitted. Both parties will notice this, and the agreement in this case is that the token holder continues in that role. No “key bit” may be assigned in this situation.

In the final exemplary predetermined condition presented in FIG. 6D, neither device advertises during the first timeslot, and this will be noticed by both parties. In principle the synchronization advertisement from the token holder (and the whole second timeslot) can be suppressed, providing an estimated 12% increase in algorithm speed. Outcome 4 does not result in a key bit being generated.

The correct working of the algorithm relies on the timely arrival of the advertising messages. Robustness is easily increased by implementing the advertisement as described in this mechanism as several successive advertising messages. Alternatively, an acknowledgement mechanism can be implemented by using extra bytes available in the advertising messages. As clock skew is an easily recognizable property of an individual device, the exact transmission time of an advertisement within a timeframe should be randomized. Assuming, that the timeslot extent is set to e.g. 1s each (a conservative estimate), the algorithm will produce 30 key bits/minute. To be noted is that the pairing need no user intervention, i.e. the only consumed effort is time. Also, if the algorithm is implemented on, for example, the Wibree™ link layer, the duration of the algorithm can most likely be squeezed to 200-300 ms. The goal of the attacker may be difficult to achieve, since the pairing devices cannot be told apart, there is no way for the attacker to differentiate between a “1”-bit and a “0”-bit. While, the attacker may be able to identify an event (e.g., the “collisions”) and possibly deduce that a pairing is being carried out, it will be extremely difficult for the attacker to get the actual pairing key security information.

More specifically, advertisement augmentation is based on the indistinguishability of two devices advertising on the same address. This can be considered secure against attacks performed with end-user devices, “dongle” analyzers or the like, but not necessarily against dedicated laboratory equipment that e.g. can perform very accurate timing and power analysis on the spot. Advertisement augmentation is compact and when run in sequence it can produce a key in around 3 seconds without user interaction and minimal code overhead. In this augmentation model, non-connecting advertisements with ADV_NONCONN_PAYLOAD_IND are used to augment the key. The augmentation is conceptually done after the first (pairing) connection and before the next data connection finalizing the augmentation in the beginning of the second connection. However, it is recommended that the whole advertisement augmentation is run as one 3 second “batch”.

After a plaintext pairing with the advertisement augmentation specified, the advertiser may generate a private address of the augmentation-mode type. The advertiser may advertise with ADV_NONCONN_IND with an advertising interval of 30*625 us for 200 ms. Then, it will go into the following loop for e.g., 126 iterations (content cₓ described later):

Advertiser:

for i=1 to 126

x=[1 ms . . . 45 ms]

sleep x

y=[1 ms . . . 5 ms]

advertise payload cᵢ with interval 1*625 us for duration of y

sleep 150 ms/*wait for the initiator to complete*/

The high-level operation of the initiator is similar. It may scan for the address given to it during pairing. When found, it may set its own address to the same value, and perform

Initiator:

sleep 150 ms/*acheive rough sync*/

for i=1 to 126

x=[1 ms . . . 45 ms]

scan for the duration of x, collect advertisement payloads from peer

y=[1 ms . . . 5 ms]

advertise payload cᵢ with interval 1*625 us for duration of y

The complete advertising phase may take approximately 3 s. When the advertiser is complete, it sets its advertisements to ADV_IND. The initiator re-connects to the advertiser with open mode and the PI bit set. The host logic in the respective devices moves to pairing, phase 1. The initiator may use, for example, 18 KEY_TRANSFORM packets to send a list of 126 stored payload packets chosen from a set of advertisements the initiator sent and the ones it received from the advertiser (the initiator will not hear its own advertisements and the advertisements the advertiser happened to send during initiator transmit). This transmission theoretically takes around 20 ms. The order and the fact whether the payload (when advertised) originated from the initiator or advertiser provides a set of 126 bits to be used (padded with 00) as the SK.

The advertiser may then respond with a KEY_CHECK PDU on the generated key SK. The pairing proceeds to phase 2 in which the final keys are exchanged, and the augmentation phase ends. The cryptographic operations for both endpoints are mostly identical. Both devices may generate, for example, a 16-byte random source S_{RAND} for the duration of the advertisement augmentation. A cₓ is generated based on a random byte bᵣ as

T=E_{Srand}

(bᵣ,0x00,0x00,0x00,0x00,0x00,0x00,0x00,0x00,0x00,0x00,0x00,0x00,0x00,0x00, 0x00,0x00)

cₓ={bᵣ,T0,T1,T2}

During the advertising phase both devices may transfer (in advertisement payload packets) their respective c₀-c₁₂₅ during the randomly spaced intervals during the 3 s duration of the pairing. The initiator can collect (when it scans) all messages it heard as well as all messages sent by it. During phase 1 of the re-connect, the initiator will select e.g. a set of 126 transferred payloads ideally balanced 50%/50% between the ones it scanned and the ones it sent, put in any order. If the number of scanned payloads is below 63 (50%), then more of the initiator's advertisement payloads is used to complete the 126 4-byte payloads to be transmitted. As the advertiser receives the payloads, it correspondingly checks whether each received 4-byte payload is one of its own or not. If it has not stored the values it transmitted, it may repeat the calculation:

dₓ={bᵣ,T0,T1,T2}

R=E_{Srand}

(bᵣ,0x00,0x00,0x00,0x00,0x00,0x00,0x00,0x00,0x00,0x00,0x00,0x00,0x00,0x00,0x00,0x00)

R0==T0, R1==T1, R2==T2?

to validate the fact. The originator of the adv. payload (advertiser=1, initiator=0) determines the 126 MSb:s of the key.

A separate issue in pairing is that there necessarily is no knowledge of the address of the other device at the outset of pairing. One way to solve the issue may be to reserve one address for “pairing purposes.” This approach has the side-effect that it is blatantly obvious for an eavesdropper that a pairing is taking place. A simple algorithm, making use of the Wibree™ privacy mechanism in a simple manner, alleviates the problem and requires an attacker to perform substantially (exponentially) more calculations to figure out the devices that currently pair. The algorithm is as follows: (1) Devices are instructed to pair, (2) Each device advertises “once” and scans the reset of the time where the interval is partly randomized, (3) Each device x starts broadcasting a random address rx(0), (4) Each device at “random intervals” makes a new private address with secret rx(t−1)|rz or rz|rx(t−1), where rz is a randomly selected other address in the neighborhood, rx(t−1) is the last address, and the ordering is predefined based on e.g. long integer order, (5) Each device stores the last address it advertised rx(t−1),a and a fixed number of the last scanned ones rz(i), (6) When a new scanned address is received, check whether the address has a secret of “rx[t−1]|some other address”, (7) If so, advertise with that address, (8) If you scan “yourself” then a pair has been found. A simple checksum handshake (connection) can be carried out to confirm the match.

An attacker (that strives to figure out what devices are pairing) needs to try all possible pairs of devices rather than a linear list of devices as is the case for the single device that is finding a party to pair with. This even provides some protection for the actual pairing algorithm, whatever that may be.

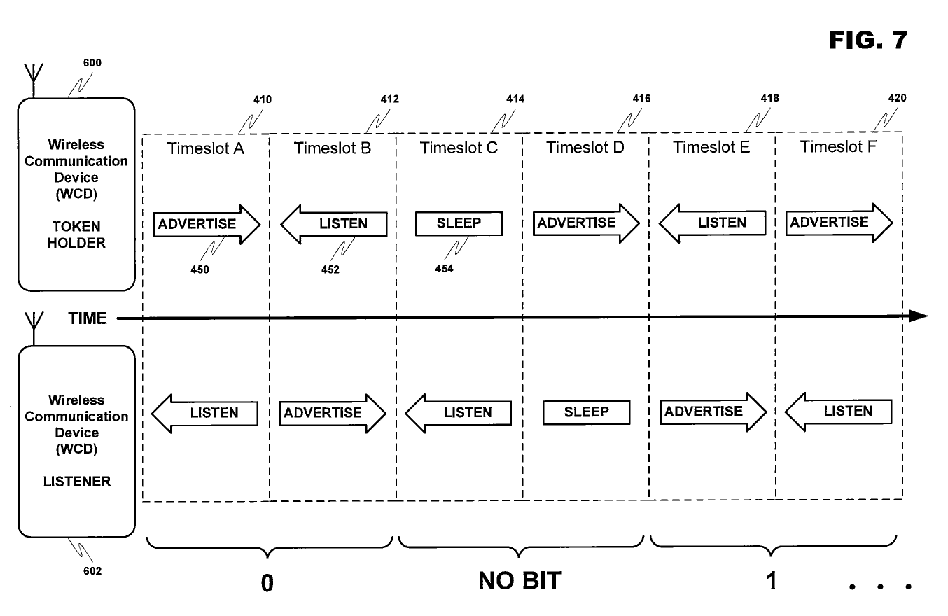

An example of key formation is disclosed in FIG. 7. Timeslots 410-418 include actions taken by the token holder 600 and listener 602, respectively. These actions may be interpreted in timeslot pairs in order to define a security key. For the first bit, timeslots A and B (410 and 412) may be taken together in order to yield a “0” for the first bit. Next, since no adverting messages are sent in timeslot C 414, which is the first slot of the pair, then no bit is assigned to the access key. Next, the combination of timeslots E and F (418 and 420) define that the next bit should be a “1” in accordance with the condition set forth in FIG. 6B. These bits may be concatenated to form an access key, along with other bits chosen via the same process.

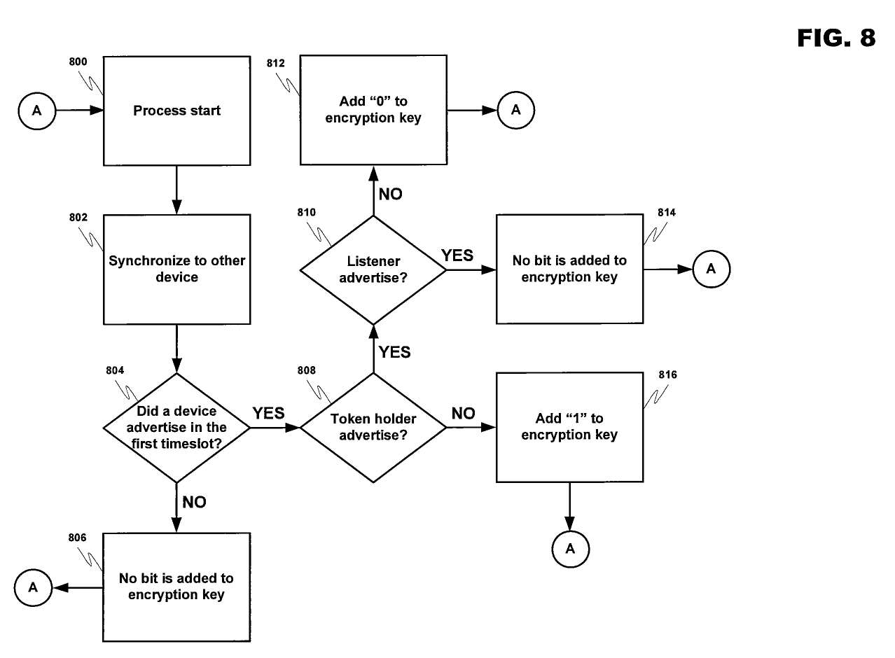

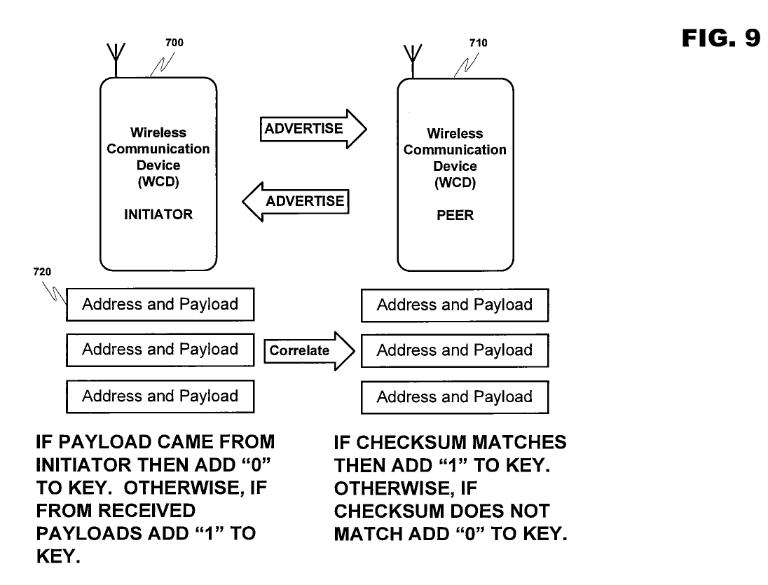

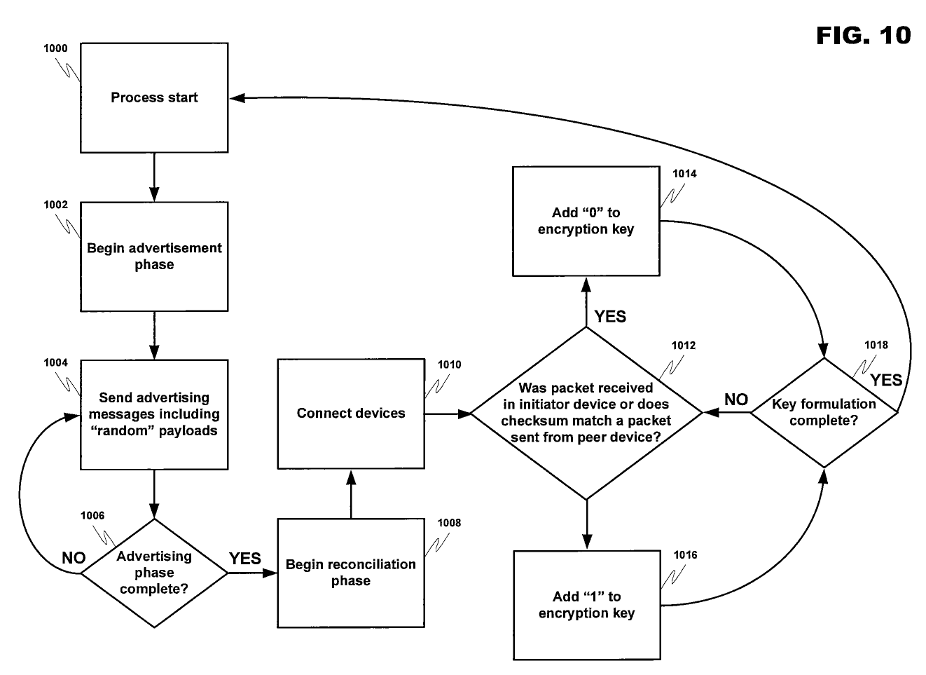

FIG. 8 discloses an exemplary process flow chart in accordance with at least one embodiment of the present invention. In step 800 the process starts followed by the synchronization of the devices in step 802. The synchronization allows familiar devices to align their clocks so that the various timeslots occur concurrently. A determination may then be made in step 804 as to whether advertising message was sent in the first timeslot of the pair of timeslots against which a condition will be determined. If no messages were sent in the first time slot, then in accordance with FIG. 4D no bit will be added to the security key in step 806. The process flow may then return to step 800.

If a device did advertise in the first timeslot, then in step 808 a determination is made as to whether the current token holder 600 issued an advertising message. If the token holder 600 did send a message, then in step 810 a check is made for the listener device 602 as to whether an advertising message was sent. If no advertisement was sent, then in step 812 a “0” is added to the encryption key and the process restarts (step 800). Otherwise, if both token holder 600 and listener 602 sent an advertising message in the first period, then in step 814 no bit is added to the encryption key (see for example FIG. 6D) and the process may resume at 800. If token holder 600 did not send an advertising message in step 808, then in step 816 a “1” may be appended to the encryption key. This occurs because it is known that at least one device sent a message in the first timeslot, per step 804, and that it was not token holder 600, per step 808. Therefore, listener 602 must have sent the advertisement message. This scenario is in accordance with FIG. 6B, and therefore, a “1” may be added to the encryption key.

### V. Key Establishment Through Payload Analysis.

In another example of the present invention, Wibree™ includes a privacy feature that makes it possible for the host to set the address for advertisements to any legitimate address. Especially it is possible for two devices to advertise with the same address. It is also possible to add payload to the advertisement packets. These features can be utilized in a pairing algorithm (i.e., the process by which two devices construct a common secret from a starting point where no such information exists) based on predetermined conditions related to payloads contained in each advertisement packet. The details regarding how two devices that want to pair with each other from the set of all possible devices in the neighborhood may be ignored. The problem is not security-relevant and is trivially solved, for example, by defining a pairing address used by all devices that wish to pair. A time synchronization should also be established between devices.

The algorithm is based on the indistinguishability of advertisements sent by the respective devices and the time period during which the pairing advertisements are sent should roughly overlap. This can, for example, be done by both devices sending advertisements stating the time left before the pairing should starts, and letting the individual device adjust its time to times reported by the peer (say a count-down period from 2000 ms, and both devices sending its own notion of time left randomly, and listening (scanning) for the peer's time-left in between.

In the case of Wibree™, the synchronization is essentially bootstrapped from the earlier initial pairing connection. The algorithm is designed around the notion that the devices participating have big differences in capabilities such as computing power and memory. This is the typical case in Wibree™, since one party typically is a sensor with limited capabilities. Additionally, a sensor may not implement the capability to connect to other devices, and as a consequence the network scanning feature might be missing. In the specification, the initiator is the more capable device (e.g., a mobile phone or WCD 100) and the advertiser possibly a sensor.

The algorithm may also use randomness from a random generator and an encryption facility Ekey (data). Both of these are services provided in Wibree™ devices by the link layer. The encryption facility in the Wibree™ case is typically an AES-128 encryption block. The existence of a clock is also required by the algorithm. In the case of Wibree™ this requirement is satisfied since the radio specification also relies on a clock for communication synchronization. Clock oscillators may additionally be considered omnipresent in any computational device including sensors.

Returning to the pairing itself, both devices will produce a set of payloads. Each payload contains a random part, and a part that is a keyed hash of the random part. The key for this operation is randomly generated by both peers individually for the duration of the pairing. To a bystander all payloads will look completely random, but the participating devices can based on the operation determine, given a payload, whether it originated from itself by re-creating the checksum of the random part and comparing the result with the checksum part.

The payloads are constructed in this fashion to save memory in the more limited device, a more straight-forward approach is to simply generate payloads at random, both devices remembering all of their own payloads. Even when generating the payloads with the checksum, the initiator needs to retain at least the random parts of its own payloads so that it can regenerate the exact set of payloads it actually sent during the advertisement phase.

Now we are at a stage where we have a shared address, a point in time and an equivalent number of payloads in both ends. During a time period both devices will transmit the payloads as advertisements at random intervals. As the current Wibree™ specification does not provide a way to tell how many advertisements are sent (only the interval), the standard specification also randomizes the time during which advertisements are sent. This may eliminate cases where the internal implementation e.g. of one device always would send 3 repetitions of the same advertisement where the other one would send 4, thus enabling an observer to tell them apart. During the advertisement phase the advertiser (e.g. the sensor) sleeps when it is not advertising whereas the initiator (e.g. the mobile phone) spends the intervals between transmissions to scan the radio for advertisements originating from the other device. Even though both devices use the same address, all advertisements received by the initiator with the common address originate from the peer since the initiator is not advertising while it is scanning.

During the advertisement phase, the initiator will store all payloads originating from the peer. Some will be lost due to simultaneous transmission, but as the intervals spent transmitting is small compared to the intervals spent scanning (or sleeping, in the _sensor_ end), the majority of the payloads of the peer should be received. The observer will see a number of advertisements for the address shared by the devices, but cannot distinguish them from each other. All carry a random-looking payload, but that does not aid in the resolving their origin. The only thing that ideally can be resolved is that if two random parts with different checksum parts appear during the advertisement phase, the observer may (if the checksum system is used) determine that the advertisements originate from different peers.

After the advertisement phase the initiator connects to the advertiser. During the connection the observer may tell the devices apart. The essence of the subsequent protocol is that the initiator selects one payload at a time either from the set of its own transmitted payloads or from the set of the payloads received from the peer. The time order in which they were sent or received is insignificant, the sets should really be treated as sets, not as lists. For each selection, the payload should be drawn from the set of own transmissions with, for example, a 50% probability, and consequently from the set of received payloads with p=50%. When a payload has been selected, it is removed from the respective set, and sent to the peer (the _sensor_. If the payload came from the set of own transmissions this will correspond to a single key bit “0” being generated, and if the payload came from the received payloads the corresponding bit will be “1”. On reception of the payload the sensor peer re-creates the checksum from the random part and compares the result against the checksum part.

If a match is found the node may designate the key bit to be “1”, otherwise to be “0”. Thus both endpoints, after the transmission of one payload agreed on one bit of the resulting key, whereas an observer would not have been able to draw the same conclusion. Now, the initiator sends over as many payloads as needed (e.g., in Wibree™, 126 payloads), resulting in a 126-bit key emerging in both ends.

To be noted is that the algorithm in the sensor node is very simple, and requires ideally only the temporary storage of the key with which the checksums are produced (e.g., the payloads may be produced on-demand), and the final key when it is constructed. The node does not need to connect anywhere, nor listen to/scan the network. Although the time values indicated in the standard are optimized for speed in the context of Wibree™, the same algorithms and principles can be used independently of time-scale. As no user interaction is needed, doing the advertisement-based key forming can well be done as a background activity.

Accordingly, it will be apparent to persons skilled in the relevant art that various changes in form and detail can be made therein without departing from the spirit and scope of the invention. The breadth and scope of the present invention should not be limited by any of the above-described exemplary embodiments, but should be defined only in accordance with the following claims and their equivalents.

1. A method, comprising:
communicating via a short-range wireless communication medium using common address information, wherein the communication includes at least one of transmitting advertising messages and receiving advertising messages;
determining whether the transmitted and received advertising messages meet a predetermined condition; and
computing security information based on the conditional determination.

2. The method of claim 1, wherein the advertising messages include an address common to a plurality of wireless communication devices communicating via the short-range wireless communication medium.

3. The method of claim 1, wherein the predetermined condition is measured over a time period including a predetermined number of periodic time slots.

4. The method of claim 3, wherein the periodic time slots are synchronized among a plurality of wireless communication devices communicating via the short-range wireless communication medium.

5. The method of claim 4, wherein the predetermined condition includes a pattern of transmitted and received advertising messages measured over a predetermined number of time slots.

6. The method of claim 5, wherein computing shared security information includes adding bits to a shared security key based on whether the predetermined condition is met.

7. The method of claim 1, wherein the transmitted and received advertising messages include at least address information and payload information.

8. The method of claim 7, wherein the payload information includes pseudorandom information computed by a device sending the advertising message.

9. The method of claim 8, wherein the predetermined condition includes a determination if the advertising message was sent by a certain wireless communication device based on a stored pseudorandom payload information.

10. The method of claim 8, wherein the predetermined condition includes a determination if the advertising message was sent by a certain wireless communication device based on whether the pseudorandom payload information matches a checksum.

11. The method of claim 8, wherein computing shared security information includes adding bits to a shared security key based on whether the predetermined condition is met.

12. The method of claim 1, wherein the shared security information is used to determine whether at least two wireless communication devices have been previously paired.

13. A computer program product comprising a computer usable medium having computer readable program code embodied in said medium, comprising:
a computer readable program code for communicating via a short-range wireless communication medium using common address information, wherein the communication includes at least one of transmitting advertising messages and receiving advertising messages;
a computer readable program code for determining whether the transmitted and received advertising messages meet a predetermined condition; and
a computer readable program code for computing security information based on the conditional determination.

14. The computer program product of claim 13, wherein the advertising messages include an address common to a plurality of wireless communication devices communicating via the short-range wireless communication medium.

15. The computer program product of claim 13, wherein the predetermined condition is measured over a time period including a predetermined number of periodic time slots.

16. The computer program product of claim 15, wherein the periodic time slots are synchronized among a plurality of wireless communication devices communicating via the short-range wireless communication medium.

17. The computer program product of claim 16, wherein the predetermined condition includes a pattern of transmitted and received advertising messages measured over a predetermined number of time slots.

18. The computer program product of claim 17, wherein computing shared security information includes adding bits to a shared security key based on whether the predetermined condition is met.

19. The computer program product of claim 13, wherein the transmitted and received advertising messages include at least address information and payload information.

20. The computer program product of claim 19, wherein the payload information includes pseudorandom information computed by a device sending the advertising message.

21. The computer program product of claim 20, wherein the predetermined condition includes a determination if the advertising message was sent by a certain wireless communication device based on a stored pseudorandom payload information.

22. The computer program product of claim 20, wherein the predetermined condition includes a determination if the advertising message was sent by a certain wireless communication device based on whether the pseudorandom payload information matches a checksum.

23. The computer program product of claim 20, wherein computing shared security information includes adding bits to a shared security key based on whether the predetermined condition is met.

24. The computer program product of claim 13, wherein the shared security information is used to determine whether at least two wireless communication devices have been previously paired.

25. A device comprising:
at least one controller coupled to a wireless communication module, wherein the apparatus is configured to:
communicate via a short-range wireless communication medium using common address information, wherein the communication includes at least one of transmitting advertising messages and receiving advertising messages;
determine whether the transmitted and received advertising messages meet a predetermined condition; and
compute security information based on the conditional determination.

26. The device of claim 25, wherein the advertising messages include an address common to a plurality of wireless communication devices communicating via the short-range wireless communication medium.

27. The device of claim 25, wherein the predetermined condition is measured over a time period including a predetermined number of periodic time slots.

28. The device of claim 27, wherein the periodic time slots are synchronized among a plurality of wireless communication devices communicating via the short-range wireless communication medium.

29. The device of claim 28, wherein the predetermined condition includes a pattern of transmitted and received advertising messages measured over a predetermined number of time slots.

30. The device of claim 29, wherein computing shared security information includes adding bits to a shared security key based on whether the predetermined condition is met.

31. The device of claim 25, wherein the transmitted and received advertising messages include at least address information and payload information.

32. The device of claim 31, wherein the payload information includes pseudorandom information computed by a device sending the advertising message.

33. The device of claim 32, wherein the predetermined condition includes a determination if the advertising message was sent by a certain wireless communication device based on a stored pseudorandom payload information.

34. The device of claim 32, wherein the predetermined condition includes a determination if the advertising message was sent by a certain wireless communication device based on whether the pseudorandom payload information matches a checksum.

35. The device of claim 32, wherein computing shared security information includes adding bits to a shared security key based on whether the predetermined condition is met.

36. The device of claim 25, wherein the shared security information is used to determine whether at least two wireless communication devices have been previously paired.

37. A system, comprising:
two or more wireless communication devices;
the two or more wireless communication devices communicating via a short-range wireless communication medium using common address information, wherein the communication includes at least one of transmitting advertising messages and receiving advertising messages;
the two or more wireless communication devices further determining whether the transmitted and received advertising messages meet a predetermined condition; and
computing security information based on the conditional determination.

38. A device comprising:
at least one controller coupled to a wireless communication module, wherein the apparatus is configured to:
communicate via a short-range wireless communication medium using common address information, wherein the communication includes at least one of transmitting advertising messages and receiving advertising messages;
store information related to each transmitted advertising message in a transmitted message set and information related to each received advertising message in a received message set;
wirelessly connect to another device, wherein during the wireless connection stored information is selected randomly from the transmitted message set and the received message set, the stored information being forwarded to the other device;
determine whether the forwarded information came from the transmitted message set or received message set; and
compute security information based on the determination.

39. A device comprising:
at least one controller coupled to a wireless communication module, wherein the apparatus is configured to:
communicate via a short-range wireless communication medium using common address information, wherein the communication includes at least one of transmitting advertising messages;
store information related to each transmitted advertising message;
wirelessly connect to another device, wherein during the wireless connection information is received from the other device;
determine whether the received information originated in the device receiving the information based on the stored information; and
compute security information based on the determination.
